(19) United States
(12) Patent Application Publication
(10) Pub. No.: US 2003/0116499 A1
(43) Pub. Date: Jun. 26, 2003

(54) Medium for isolating, detecting, separating, or purifying chemical and biological substances

(76) Inventors: Bennett C. Ward, Midlothian, VA (US); Ulises C. Sanroma, Chester, VA (US); Dan O. Finch, JR., Providence Forge, VA (US); Curtis N. Fallecker, Hopewell, VA (US); Ronald E. Billups, Richmond, VA (US)

Correspondence Address: The Jenifer Building, 400 Seventh Street, N.W., Washington, DC, 20004-2201, US

(21) Appl. No.: 10/259,647

(22) Filed: Sep. 30, 2002

Related U.S. Application Data
(60) Provisional application No. 60/326,994, filed on Oct. 5, 2001.
(60) Provisional application No. 60/341,285, filed on Dec. 20, 2001.

(51) Int. Cl. B01D 71/26

(52) U.S. Cl. 210/500.36; 210/500.41; 210/502.1; 422/101

(57) ABSTRACT

Disclosed herein is a medium for analyzing a substance in a mixture and method of making and using. In particular, the medium comprises a network of at least one polymeric fiber having a derivatized polymeric surface which allows immobilization of at least one selective binding agent thereon in a highly dispersed and randomly spaced orientation which forms a tortuous interstitial path for passage of the mixture therethrough. The substance may be a chemical substance or a biological substance. Also disclosed are assay matrices, assay systems and kits comprising the medium.

### BACKGROUND OF THE INVENTION

1. Field of the Invention

The present invention relates to medium for isolating, detecting, separation, or purifying chemical and biological substances. In particular, the present invention relates to analytical and purification methods using polymeric fibers for various clinical, diagnostic, medical and research purposes.

2. Description of the Related Art

There is a continuing need in biomedical research and development for analytical and diagnostic methods and reagents. Specifically, there is a continuing need for assays and purification methods and systems for chemical and biological substances such as drugs, narcotics, hormones, steroids, amino acids, metabolites, toxins, viruses, microorganisms, and nucleic acids.

Isolation, purification, or separation of a given substance from a mixture has been accomplished in various ways and for a variety of reasons. The most common prior art separation method comprises simple filtration with a porous filter which allows certain substances to pass through the filter, while physically capturing and retaining other substances by mechanical sieving, i.e., removal of particles by physical entrapment when the pore size of the filter is smaller than the particle size. To remove very fine substances by simple filtration, the filter must obviously have fine pores. Unfortunately, the fine pores are readily clogged by the fine substances and other contaminants. As a result, a filter medium having fine pores quickly presents unacceptably high pressure drops, loses its effectiveness, or both.

The isolation, separation, or purification of chemical and biological substances from mixtures generally requires more than simple filtration. There are numerous assays and purification methods and systems for chemical and biological substances in the prior art. Many of these methods are based on specific binding reactions wherein the ligand, substance to be detected, measured, or isolated, reacts specifically and preferentially with a receptor molecule. Examples of specific binding reactions include binding reactions between antibodies and antigens and avidin and biotin.

The prior art methods using specific binding reactions generally require a bioaffinity agent, such as a ligand or receptor molecule, immobilized on a solid substrate, so any substances that do not bind the ligand or receptor molecule can be separated from the ligand and receptor complex. Thus, such immobilized ligands and receptor molecules are commonly used in affinity chromatography and other purification systems to isolate a given chemical or biological substance from a mixture.

Other prior art methods for isolation, purification, or separation include ion exchange media and derivatized beads. The ion exchange media, which are primarily made of sulfonated polymers, are problematic as they are highly ionic, are extremely reactive toward derivation with crosslinking agents, and have a residual ionic character after derivation which interferes with binding reactions and may also damage or destroy the biological and chemical substances to be analyzed, isolated, or purified. The anion exchange resins have sulfonyl groups that are active and can release target analytes by exchanging with an analyte of a greater affinity. The resins are typically beads or particulates. The anion exchange resins are also problematic in that the high ionic strength often damages or destroys chemical and biological compounds.

Derivatized beads such as silica, functionalized, magnetic, and porous plastic beads are problematic for a variety of reasons. For example, as it is difficult or impractical to fix the beads on a solid support, the beads are usually free floating or packed in a container, which leads to poor or unreliable results due to channeling, poor flow, high pressure drops, and fouling.

For example, regardless of how carefully and completely a column of beads or the like is prepared or packed, a mixture passing through the column will seek the path of least resistance which may be the interstitial space between the beads or the space between the beads and the column containing the beads, thereby bypassing the interaction sites on the beads and significantly reducing the effectiveness of the process. Furthermore, like simple filters, packed columns of beads suffer from clogging. To prevent clogging, the porosity of the beads has been increased; however, the increased porosity reduces the active surface area and also renders the beads quite fragile. Additionally, it is difficult to prepare kits and off-the-shelf assays using free floating beads as the beads must be carefully prepared and packed for each use.

Semipermeable membranes are also problematic as the two-dimensional nature of membranes limits their use to only a few applications and provides a limited amount of surface area for interaction as compared to the surface areas of three-dimensional forms. The membranes must be relatively thin so that resistance to diffusion is minimal. However, the integrity of thin membranes is difficult to maintain and an experiment wherein the membrane does not remain intact, must be repeated. Additionally, like simple filters, the pores of membranes are subject to clogging.

Considering the foregoing, the prior art media for the isolation, separation, or purification of chemical and biological substances suffer significant disadvantages including limited initial efficiency, reduced effectiveness with use resulting from clogging, undesirable fragility, difficulty and expensive to manufacture and prepare, or a combination thereof.

Thus, a need exists for a medium that may be used to isolate, separate, or purify chemical and biological substances from a mixture by physical entrapment, specific binding, or both that is relatively inexpensive and is easy to make and use.

### SUMMARY OF THE INVENTION

The present invention generally relates to a medium for isolating, detecting, analyzing, separating, or purifying a substance in a mixture.

In some embodiments, the present invention relates to a medium for analyzing at least one substance in a mixture comprising a network of at least one polymeric fiber having a derivatized polymeric surface in a highly dispersed and randomly spaced orientation which forms a tortuous interstitial path for passage of the mixture therethrough. The substance may be a chemical substance or a biological substance. In preferred embodiments, the fibers of the network are bonded at their points of contact to produce a substantially self-sustaining, three-dimensional, and substantially water insoluble substrate. The network may further comprise a second polymeric fiber as a bonding fiber or to provide a second polymer surface having a different binding specificity, affinity, or both. The second polymer surface may specifically bind a separate substance in the mixture being treated. Additionally, the network may further comprise derivatized beads which may have the same or different binding specificity, affinity or both as the derivatized polymeric surface of the polymeric fiber.

In preferred embodiments, the polymeric fiber comprises a thermoplastic polymer. Preferably, the polymeric fiber is a sheath-core bicomponent fiber. The thermoplastic polymer may be a hydrocarbon resin, polyamide, polyethylene, polyvinyl chloride, or a polyester, or can be copolymers such as copolymers of ethylene, propylene, ethylene methacrylic acid, ethylene acrylate acid, ethylene-vinyl acetate, ethylene methyl acrylate, polystyrene, nylon 6, polyethylene terephthalate, polybutylene terephthalate, and derivatives thereof. In preferred embodiments, the thermoplastic polymer is a block copolymer of polycaprolactam and polyethylene oxide diamine, such as Capron® hydrophilic nylon, available from Honeywell, or a copolymer of ethylene and methacrylic acid, such as Nucrel® available from DuPont, or a combination thereof.

In other embodiments, the present invention relates to a medium for analyzing at least one substance in a mixture of the type described above made by continuously spinning by conventional methods, which include melt spinning, melt blowing, or spun bonding or solution spinning such as dry spinning or wet spinning, a plurality of fibers having at least a surface comprising the thermoplastic polymer through a plurality of openings in a die, collecting the fibers on a continuously moving surface to form a highly entangled web of the fibers in the form of the network of highly dispersed continuous fibers randomly spaced primarily in the direction of movement of the moving surface, gathering the network, heating network to bond the fibers to each other at their points of contact, and cooling said network to give the medium. In preferred embodiments, the network is heated with steam.

In some embodiments, the present invention relates to an assay matrix for a chemical or biological assay comprising a specific binding agent immobilized on a medium as described above.

In some embodiments, the present invention relates to an assay system comprising the assay matrix of the present invention. The assay system may be an assay tray, a column, a hypodermic needle, a membrane, a microcentrifuge tube, or the like.

In some embodiments, the present invention relates to a kit comprising the aforementioned medium for analyzing at least one substance in a mixture comprising a network of at least one polymeric fiber in a highly dispersed and randomly spaced orientation which forms a tortuous interstitial path for passage of the mixture therethrough packaged together with at least one chemical or biological assay reagent. The kit may further include instructions for use.

In some embodiments, the present invention relates to a method for analyzing at least one substance in a mixture comprising immobilizing at least one specific binding agent to a network of at least one polymeric fiber having a polymeric surface which allows immobilization of at least one specific binding agent thereon in a highly dispersed and randomly spaced orientation which forms a tortuous interstitial path for passage of the mixture therethrough. The substance is a chemical substance or a biological substance such as an amino acid molecule, a peptide, a polypeptide, a nucleic acid molecule, a polynucleotide, a sugar, a carbohydrate, a lipid, or the like. The substance may be a therapeutic agent. In preferred embodiments, the polymeric fiber comprises a plurality of interaction sites capable of specific or covalent bonding with a crosslinking agent, a specific binding agent, or both. The substance may be isolated, purified, or separated from the mixture by physical entrapment. Alternatively the substance may be isolated, purified, or separated from the mixture by specific, ionic, or covalent bonding to the medium, the crosslinking agent, the specific binding agent, or a combination thereof. The method may further include eluting the substance from the medium.

It is to be understood that both the foregoing general description and the following detailed description are exemplary and explanatory only and are intended to provide further explanation of the invention as claimed.

### DETAILED DESCRIPTION OF THE INVENTION

The present invention relates to a medium for isolating, analyzing, separating, purifying, or a combination thereof at least one chemical or biological substance in a mixture and methods of making and using thereof. Specifically, the medium is a polymeric fiber that may be used in various clinical, diagnostic, medical and research methods and systems.

The medium of the present invention comprises at least one polymeric fiber that may covalently interact with a variety of substances such as acidic, basic organic, or inorganic compounds. The polymeric fiber comprises a plurality of interaction sites for covalently or chemically modifying the polymeric fiber. For example, a crosslinking agent or a specific binding agent may be immobilized on the polymeric fiber by covalent coupling. The immobilized specific binding agent may then specifically bind at least one substance such as a biomolecule.

The polymeric fiber is functionalized, derivatized, or modified to confer a greater activity, reactivity, or affinity to a crosslinking agent, a specific binding agent, or both. As used herein, “functionalized”, “derivatized”, or “modified” are used interchangeably to refer to a polymeric fiber capable of immobilizing a specific binding agent to its surface. For example, interaction sites or pendant groups on the surface of a polymeric fiber may be covalently reacted with a crosslinking agent which may be a specific binding agent, or be used to immobilize a specific binding agent. The pendant groups include carboxylic acid groups, amine groups, sulfonic acid groups, and the like. A polymeric surface that does not already have interaction sites or pendant groups may be treated to provide such sites or groups on its surface. For example, polystyrene may be reacted with sulfuric acid to give a sulfonated surface. The polymeric surface is then reacted with a crosslinking agent which may be a specific binding agent or used to bind a specific binding agent.

As used herein, a “specific binding agent” is commonly known in the art as a “bioaffinity agent” and refers to a ligand or a receptor molecule that is specific for a given substance. The most common receptor molecules are antibodies and specific binding proteins known in the art. Receptors are characterized by having a reversible specific binding affinity for a ligand. The ligand may further comprise a detectable marker such as an enzyme or a fluorescent tag that binds to the receptor molecule, the ligand, or both with substantially the same or similar specificity and affinity as the ligand to the receptor. Suitable specific binding agents include antibodies and fragments thereof, antigens, polypeptides, polynucleotides, polysaccharides, lipids, and the like.

The specific binding agent may be immobilized on the polymeric fiber surface of the medium of the present invention. The binding may be temporary or reversible by simply contacting the ligand or receptor molecule to the polymeric fiber, or the binding may be permanent or irreversible using a crosslinking agent. Conventional methods by which a receptor molecule or ligand can be immobilized on the polymeric fiber include adsorption, absorption, covalent bonding, immunocomplexing, or a combination thereof. See, for example, U.S. Pat. Nos. 3,857,931, 4,138,383, 4,181,636, 4,264,766, 4,401,765, 4,415,700, 4,794,090, 5,063,109, 5,094,962, 5,225,516, 5,262,297, 5,599,667, 5,637,508, 5,861,319, and 5,993,935, all of which are herein incorporated by reference in their entirety.

As used herein, a “crosslinking agent” refers to an agent that may be used to link, attach, or immobilize a given substance to the interaction sites of a polymeric fiber according to the present invention. Amine crosslinking agents such as glutaraldehyde react with the amine groups of the specific binding agent and the amine groups of the polymer surface are suitable. Other suitable amine crosslinking agents include di- or trifunctional amine reactive agents such as diepoxides, di- or triisocyanates, disuccinimidyl suberate or dimethyl suberimidate, and the like. Alternatively, the amino groups on the polymer surface can be attached to the carboxylate groups of the specific binding agent using crosslinking agents such as carbodiimides or carbonyldiiumidazoles. The crosslinking agent may be added before, with or after application of the specific binding agent.

Although less preferable, a crosslinking agent need not be used according to the present invention. For example, a specific binding agent may be contacted with the medium of the present invention and fixed to the polymeric fibers by drying or other suitable means. Immobilization of the specific binding agent may not be permanent, but may be suitable and sufficient for analyzing substances in certain situations. Additionally, as nonspecific protein binding is often undesirable, the medium of the present invention may be treated to confer resistance to nonspecific protein binding by conventional methods in the art.

The medium may be in the form of a network of at least one polymeric fiber in a highly dispersed and randomly spaced configuration. The network provides a tortuous interstitial path for passage or entrapment of a substance. The network also provides a large total surface area upon which the plurality of interaction sites are capable of covalently interacting with a specific binding agent. The network comprising specific binding agents immobilized thereon may be used for analyzing a substance such as a biomolecule. As used herein, the terms “analyzing” a substance may denote “isolating”, “detecting”, “measuring”, “separating”, “purifying”, “assaying”, or “characterizing” the substance which may be known or unknown.

The polymeric fibers are preferably bi-component thermoplastic polymeric fibers made by spinning by conventional methods, which include melt spinning, melt blowing, or spun bonding or solution spinning such as dry spinning or wet spinning or cold drawing. Preferably, the polymeric fibers are made by melt spinning. The polymeric fibers may be mono- or multi-component fibers such as bi-, tri- or more. The polymeric fibers may then bonded by conventional “melt blowing” or “spun bonding” techniques into a network of highly dispersed and randomly spaced polymeric fibers. The network may then be thermally bonded into a desired shape or structure with a heat source such as hot air or steam.

Various commonly owned prior art patents clearly show and describe preferred processing techniques and apparatus for forming a three-dimensional substantially self-sustaining, substrate defining a tortuous path for passage of a fluid mixture therethrough, wherein the substrate comprises a network of randomly spaced polymeric fibers bonded at their points of contact. For example, reference may be made to U.S. Pat. Nos. 5,509,430, issued Apr. 23, 1990, and 6,026,819, issued Feb. 22, 2000, the disclosures of each of which are incorporated herein in their entirety. These patents disclose the production of such substrate from melt-blown bicomponent fibers, a preferred process for the production of the underlying or untreated substrate according to this invention.

Of particular interest is U.S. Pat. No. 6,103,181 ('181 patent), issued Aug. 15, 2000, the disclosure of which is also incorporated herein in its entirety, wherein a web of mixed polymeric fibers can be produced and steam bonded into a self-sustaining, three-dimensional substrate to be treated in accordance to this invention to form a medium for analyzing chemical and biological substances. The method and apparatus of the '181 patent can form a uniform web of mixed polymeric fibers, the surfaces of some of which can be derivatized or modified, with different polymeric fibers functioning to bond the polymeric fibers to each other at their points of contact. The polymeric fibers may be bicomponent polymeric fibers in which the sheath may be derivatized or modified and the core is a relatively inexpensive supporting material the same as, or different from, the bonding polymeric fibers.

It is even possible, using the technology of the '181 patent, to produce a uniform web of mixed bicomponent polymeric fibers where the core of both fibers is the same and the sheaths are different polymeric materials each of which may be derivatized or modified to bind different substances in a mixture. Thus, the sheaths of the polymeric fibers may function both to bond the polymeric fibers together where they come in contact into a stable porous substrate and to specifically bind at least one substance in a mixture.

While the aforementioned patents provide preferred techniques and apparatuses for forming the self-sustaining substrate or network of the medium for analyzing chemical and biological substances according to this invention, other well-known processing technology is available and may be readily adapted for the production of the medium of the present invention by those skilled in the art.

The polymeric fibers of the present invention preferably comprise thermoplastic polymers. The suitable polymers include hydrocarbon resins, polyamides, polyethylene, polyvinyl chloride, and polyesters, or can be copolymers such as copolymers of ethylene, propylene, ethylene methacrylic acid, ethylene acrylate acid, ethylene-vinyl acetate, ethylene methyl acrylate, polystyrene, nylon 6, polyethylene terephthalate, polybutylene terephthalate, and derivatives thereof. In preferred embodiments, the thermoplastic polymer is a block copolymer of polycaprolactam and polyethylene oxide diamine, such as Capron® hydrophilic nylon, or a copolymer of ethylene and methacrylic acid, such as Nucrel®, or a combination thereof. Other suitable polymers include Surlyn® (DuPont) and cationic di-polyesters.

In preferred embodiments, the medium is a fibrous medium comprising a plurality of polymeric fibers having at least a surface of a copolymer selected from the group consisting of nylon 6, polyethylene oxide diamine, ethylene methacrylic acid, and combinations thereof. The polymeric fibers may be bonded at their points of contact to form interconnecting passages from one end to the other. For example, the plurality of polymeric fibers may be extruded in any conventional manner from a spinneret onto a continuously moving surface to form an entangled fibrous mass which may be calendered to bond the polymeric fibers to each other and thereby form a porous sheet or pad. Alternatively, a bonding agent may be incorporated by any conventional manner into a mass of polymeric fibers bonded at their points of contact into a three-dimensional porous medium defining a tortuous path for passage of a mixture therethrough.

The medium of the present invention may comprise a plurality of polymers. For example, the medium may comprise a polymeric fiber comprising more than one polymer or the medium may comprise at least two polymeric fibers having different polymers. The medium of the present invention comprising a plurality of polymers may be made by any conventional manner. For example, at least one polymeric fiber comprising a first polymer may be gathered with at least one polymeric fiber comprising a second polymer into a rod-like shape and passed through sequential steam-treating and cooling zones to form a continuous three-dimensional fibrous medium having at least one portion of the first polymer and at least one portion of the second polymer. The polymeric fiber may be a bicomponent polymeric fiber formed by any conventional manner. For example, the biocomponent polymeric fiber may comprise a sheath of a first polymer and a core of a second polymer. The medium comprising at least two different polymers may be formed by bonding a polymeric fiber comprising a first polymer with a bonding agent fiber comprising a second polymer.

In some embodiments, the medium comprises a mixture of different polymers that may be functionalized to have a plurality of binding affinities, binding specificities, or a combination thereof and may then be used to analyze a plurality of substances in a mixture. For example, a medium having a mixture may comprise at least one polymeric fiber comprising one polymer and another polymeric fiber comprising a different polymer. Alternatively, derivatized beads may be attached, immobilized, or combined with the network of the polymeric fibers to provide a medium that is a mixture of the polymeric fibers and beads. Of course, the polymeric fibers may comprise one type of polymer and the beads may comprise a different type of polymer.

The medium comprising the polymeric fiber or the plurality of polymeric fibers may be formed into a continuous three-dimensional shape which may be inserted into a housing to provide a tortuous path for passage of a mixture therethrough. The three-dimensional shape may be self-supporting. It should be noted that the medium of the present invention may be formed into any desired shape. For example, the polymeric fiber or network may be formed into a columnar shape that may be inserted into a column for use in purification and separation methods. The medium may be formed into discs that may be inserted into microcentrifuge tubes or the wells of assay plates. The medium may be formed into a shape that may be inserted into a reservoir of a hypodermic needle. The medium may be formed into sheets and regular or irregular cross sectional bonded fiber shapes. Clearly, the variety of shapes in which the medium of the present invention may be formed is innumerable.

The medium of the present invention may be used to analyze at least one substance in a mixture by passing the mixture through the network or contacting the mixture with the derivatized polymeric fiber. The medium of the present invention isolates, separates, purifies, or a combination thereof a substance by physical entrapment, ionic binding, covalent binding, specific binding, or a combination thereof. The substance bound or trapped by the medium may be analyzed by determining its physical characteristics, chemical characteristics, or both based on the physical and chemical characteristics of the derivatized polymeric fiber used. The substance may be further analyzed by conventional methods in the art such as immunoassay methods and HPLC.

The binding of the substance to the derivatized polymeric fiber may be reversible or irreversible. Tonically bonded substances may be easily released from the interaction sites of the network with a dilute acid or an inorganic salt. For example, a dilute acid solution may be used to elute a given substance from the network. Additionally, the substance may be released by an alkaline metal carbonate or hydroxide. Thus, a substance may be isolated, separated, or purified from other substances, such as contaminants, by contacting a mixture or a solution comprising the substance and contaminants with the derivatized medium of the present invention. The substance or contaminant bonded to the derivatized network may be eluted in a manner similar to conventional elution methods known in the art.

Clearly, the medium of the present invention is extremely versatile and may be used in a variety of applications for isolating, detecting, analyzing, separating, purifying, or a combination thereof substances. A few examples of such applications include diagnostics such as calorimetric and dipstick assays for testing samples such as urine, blood, and other bodily fluids, viral detection, nucleic acid detection and purification, and analytical chemistry preparation and chromatography. See, for example, U.S. Pat. Nos. 5,656,448 and 5,667,976, both of which are herein incorporated by reference in their entirety.

The following examples are intended to illustrate but not to limit the invention.

### EXAMPLE 1

### Method of Making Polymeric Fiber and Network Thereof

A. Nucrel®: A Bi-component Polymeric Fiber with Carboxyl Groups on the Surface

A bi-component polymeric fiber comprising a sheath of a copolymer of ethylene and methacrylic acid and a core of polypropylene was melt spun by conventional methods. The sheath polymer comprised about 10% by weight methacrylic acid monomer and is commercially available from DuPont under the trade name Nucrel®. The undrawn yarn was made of 8 denier filaments comprising about 40% sheath by weight. Leave out next sentence.

The yarn was drawn 350 percent, crimped and bulked in order to make a multi-yarn tow. This bulked tow is then entangled to form a randomly spaced configuration via high-pressure air entangling. The tow is then rapidly heated with low-pressure steam in a die, and then directed to a cooled die, forming a highly porous bonded three-dimensional structure.

B. Hydrophil®: A Bi-component Polymeric Fiber with Amine Groups on the Surface

A bi-component polymer yarn comprising about a 40% by weight sheath of hydrophilic nylon and about a 60% core of polyethylene terephthalate was melt spun by conventional methods. The hydrophilic nylon is commercially available from Allied-Signal (now Honeywell or General Electric) under the trade name of Capron® which is a block copolymer of polycaprolactam and polyethylene oxide diamine.

The yarn was drawn 300 percent, crimped and bulked in order to make a multi-yarn tow. This bulked tow is entangled to form a randomly spaced configuration via high-pressure air entangling. The yarn was then rapidly heated in an air oven between 450° F. and 500° F. for a period of less than about 10 seconds and directed to a heated forming die to form a highly porous, bonded three-dimensional structure and then air cooled.

### EXAMPLE 2

### Functional Group Density of Polymeric Fibers

The functional group density, the amount of carboxyl or amine groups, of the polymeric fibers of the present invention may be assayed according to conventional methods in the art. Specifically, the surface activity of Nucrel® polymeric fibers or Capron® SJES hydrophilic Nylon fibers may be determined as follows.

In the following examples, PBS is a phosphate buffer solution which is made by the following recipe: a solution in deionized water of 137 mM sodium chloride (Fisher Pittsburgh, Pa.), 2.7 mM potassium chloride (Fisher, Pittsburgh, Pa.) and 10 mM, 7.4 pH, phosphate buffer solution supplied by EM Science/Merck, Darmstadt, Germany.

Three samples, 10 mg, 50 mg, and 100 mg, of Nucrel® fibers and nylon (Capron® SJES hydrophilic nylon/PET) fibers were pretreated by successive washes with 2 ml deionized H₂O/10 mg fiber, 2 ml isopropanol/10 mg fiber, and 2 ml 1M NaOH/10 mg of Nucrel® fibers or 2 ml 4M HCl/10 mg of Capron® SJES hydrophilic Nylon fibers. Then the fibers were washed 4 times with 2 ml deionized H₂O/10 mg fiber followed by a wash of 2 ml PBS/10 mg fiber. The fibers were then soaked in PBS for about 30 to about 60 minutes at room temperature. The fibers were washed 3 times with 2 ml PBS/10 mg fiber.

The surface activity of the carboxyl groups on the Nucrel® fibers was determined to be about 0.007 to about 0.03 μeq/cm² by titration and the surface activity of the amine groups on the nylon fiber was determined to be about 0.001 to about 0.02 μeq/cm² by ninhydrin assay and by titration.

To determine the surface activity of the polymeric fibers via the ninhydrin assay, the following protocol was followed. Ninhydrin solution A was prepared by making a phenol solution comprising 40 g of crystalline phenol (Fisher, Pittsburgh, Pa.) in 10 ml ethanol, then dissolving 65 mg KCN (Fisher, Pittsburgh, Pa.) in 100 ml dH₂O, preparing a dilute KCN solution by diluting 2 ml of the KCN solution with pyridine (Aldrich, Milwaukee, Wis.) up to 100 ml. Then the phenol solution was added to the diluted KCN solution to give the Ninhydrin A solution. Ninhydrin B solution was prepared by dissolving 2.5 g of ninhydrin (Pierce, Rockford, Ill.) in 50 ml ethanol. A standard ninhydrin curve was prepared and plotted for 6-aminocaproic acid (EACA) (Sigma, St. Louis, Mo.). 10 mg, 50 mg, and 100 mg samples of the polymeric fibers to be tested were pretreated as described above. Then 100 μl of Ninhydrin A solution and 25 μl of Ninhydrin B solution was added and then incubated at 100° C. for 10 minutes. Then 775 μl of 50% ethanol was added. The samples were centrifuged at 2000 rpm for 5 minutes and the absorbance of the supernatants were read at 550 nm with a UV spectrophotometer. The activity in the unknown samples was then deduced from the standard curve.

Further ninhydrin and 3H-acetic anhydride assays on the nylon (Capron® SJES hydrophilic nylon/PET) media and the Nucrel® media were conducted to determine the amine and carboxyl group density on the surfaces of the nylon (Capron® SJES hydrophilic nylon/PET) and Nucrel® fibers.

A. Ninhydrin Assay

The media of the present invention comprising nylon (Capron SJES hydrophilic nylon/PET) or Nucrel® (Nucrel 535/PP) fibers were pretreated as follows: about 50 mg of the media were washed in 1 ml of water and 1 ml of isopropanol. The Capron® SJES hydrophilic Nylon medium was rinsed with 1 ml 4N HCl, and the Nucrel® medium was rinsed with 1 ml 1N NaOH. The media were then washed with four times with 1 ml water, and two times with 1 ml PBS. During pretreatment, the control sample, Nylon6 dissolved when treated with HCl, so another control sample, pretreated without the HCl step, was used. Samples, Nyn-D 2895 and 2896 were stable and the full pretreatment was done.

All samples were assayed in triplicate on 50 mg amounts. As before, nanomoles of free amino groups were quantitated by comparison to a standard curve using 6-aminohexanoic acid as the standard. The results are summarized in Table 1.

TABLE 1

| | | | | Amine group |
|---|---|---|---|---|
| | Absorbance | Average | Number of amine | density |
| Filter Type | @ 550 nm | Abs | groups (nmol) | nmol/mg |
| NYN6 | 1.104 | | | |
| | 0.919 | 1.115 | 920 | 18.4 |
| | 1.322 | (1:10) | (incor. dil.) | |
| Nyn D 2895 | 0.884 | | | |
| | 0.486 | 0.685 | 58 | 1.16 |
| | 0.725 | | | |
| Nyn D 2896 | 0.190 | | | |
| | 0.518 | 0.354 | 32 | 0.64 |
| | 0.266 | | | |

Thus, the results for Nyn D 2895 and 2896 are similar to the previous results obtained and the results for NYN6 are about 20-fold higher.

B. 3H-Acetic Anhydride Assay

For this assay, neat acetic anhydride was obtained from American Radiolabeled Chemicals (St. Louis, Mo.) having a specific radioactivity of 90 μCi/μmol. It was diluted 1:100 with neat acetic anhydride to produce a working solution of 10.6 M with a specific radioactivity of 0.9 μCi/μmol (1.98e6 DPM/μmol or 2.2e7 DPM/μl).

The samples were pretreated as before. For the reaction, 10 μl of acetic anhydride working solution was diluted to 500 μl of water, then added to 50 mg of pretreated sample. The mixture was incubated at room temperature for 2 hours with continuous gentle shaking. The reaction solution was removed and then the sample was washed in a spin apparatus 3 times with 1 ml PBS, then 3 times with 1 ml of water. All washes and samples were counted. Duplicate reactions were done with 50 mg of each type of sample.

The micromoles incorporated were then calculated from the detected radioactivity in conduction with the specific radioactivity and the ³H counting efficiency of the scintillation counter (0.51 CPM/DPM). The results are summarized in Table 2.

TABLE 2

| | | | | acetic anh |
|---|---|---|---|---|
| Sample | | radioactivity | Number of moles | reactivity |
| name | Trial # | (CPM) | ³H (μmol) | (nmol/mg) |
| Nucrel | Nucrel 1 | 6,881,164 | 6.88 | 138 |
| | Nucrel 2 | 7,081,821 | 7.08 | 142 |
| | Average | 6,981,493 | 6.98 | 140 |
| Capron SJES | Nylon 1 | 53,394 | 0.053 | 1.06 |
| hydrophilic | | | | |
| Nylon | | | | |
| | Nylon 2 | 61,160 | 0.061 | 1.22 |
| | Average | 57,277 | 0.057 | 1.15 |

Thus, the Nucrel® media appear to be more than 100-fold more reactive, substitution level of about 140 mmol per mg sample, than the nylon (Capron® SJES hydrophilic nylon/PET) media.

The assay was repeated with new samples and the results are summarized in Table 3.

TABLE 3

| | | | | acetic |
|---|---|---|---|---|
| Sample | | Radioactivity | Number of moles | anh.reactivity |
| Name | Trial # | (CPM) | ³H (μmol) | (nmol/mg) |
| LDPE | LDPE 1 | 60,611 | 0.056 | 1.12 |
| | LDPE 2 | 87,885 | 0.081 | 1.63 |
| | Average | 74,248 | 0.069 | 1.37 |
| Nucrel 2893 | 2893 1 | 6,566,192 | 6.080 | 121.60 |
| | 2893 2 | 7,475,191 | 6.921 | 138.43 |
| | Average | 7,020,692 | 6.501 | 130.01 |
| Nucrel 2894 | 2894 1 | 6,180,780 | 5.723 | 114.46 |
| | 2894 2 | 6,445,982 | 5.969 | 119.37 |
| | Average | 6,313,381 | 5.846 | 116.91 |

As shown above, the results (Table 3) with acetic anhydride are similar to the previous results (Table 2) obtained. The control provide the expected result and reacted at a level of about 1% of the samples.

In addition to reacting with amines to form amides, anhydrides can react with alcohols to form esters. To test the possibility of ester formation, duplicate samples were reacted with acetic anhydride and washed as before. Then one of the derivatized samples was treated with 500 μl of 1 M NaOH at room temperature for 1 hour. The sample was then washed 3 times with 1 ml of water and then all washes and samples were counted. The results are shown in Table 4. For each sample pair, the #1 sample was only derivatized and the #2 sample was derivatized and treated with NaOH.

TABLE 4

| | | Radioactivity | Number of moles | acetic anh. |
|---|---|---|---|---|
| Sample Name | Trial # | (CPM) | ³H (μmol) | reactivity(nmol/mg) |
| Nucrel | Nucrel 1 | 14,406,763 | 14.4 | 288 |
| 50 mg | Nucrel 2 | 9,227,104 | 9.22 | 184 |
| | Difference (1-2) | 5,179,659 | Percent remaining (2/1) 64.0 | |
| | NaOH washes | 3,767,280 | | |
| Capron SJES | Nylon 1 | 89,483 | 0.089 | 1.78 |
| hydrophilic Nylon | | | | |
| 50 mg | Nylon 2 | 54,197 | 0.054 | 1.08 |

| | | |
|---|---|---|
| Difference (1-2) | 35,286 | Percent remaining (2/1) 60.6 |
| NaOH washes | 49,610 | |

As shown above, the substitution levels were similar to those obtained previously, and again, 100-fold more was incorporated into the Nucrel® media than the Capron SJES hydrophilic Nylon media. For both samples, about ⅓ of the counts were liberated with the NaOH treatment and the difference could be accounted for in the washes. The ⅔ that remained appeared to be stabily bound by resistance to base hydrolysis.

### EXAMPLE 3

### Derivatization or Functionalization of Interaction Sites or Functional Groups

The polymeric fibers of the present invention possess amine groups, carboxyl groups, or both in a suitable surface concentration that may be reacted with a crosslinking agent to bind a specific compound such as an enzyme or antigen which then specifically binds a given chemical or biological substance. Using conventional methods in the art, this method may be used to create the derivatized polymeric fibers of the present invention. Preferably, the derivatized or functionalized polymeric fibers allow the detection, measurement, or both of the given chemical or biological substance.

For example, using conventional methods in the art, a polymeric fiber or a three-dimensional network of at least one polymeric fiber comprising a hydrophilic nylon sheath having active amine groups on the surface in the amount of from about 0.001 to about 0.02 μeq/cm², is reacted with a crosslinking agent having at least one biotinylated end and at least one reactive end being reactive with primary amines. An example of a suitable crosslinking agent is EZ-link sulfo-NHS-SS-Biotin (EZ-Link) (Pierce, Rockford, Ill.). Since EZ-Link is reactive with primary amines, no catalyst is required. The crosslinking agent further comprises a disulfide linker between the biotinylated end and the reactive end, which disulfide linker is cleavable with at least one reducing agent.

Following this crosslinking reaction, the polymeric fibers are washed and incubated with strepavidin-alkaline phosphatase (Pierce, Rockford, Ill.), which binds the biotin moieties crosslinked to the polymeric fibers. The polymeric fibers are washed and the disulfide linker is cleaved with the reducing agent. The biotin-strepavidin-phosphatase complex is assayed and the values are compared to a standard curve. A suitable substrate such as PNPP, an alkaline-phosphatase substrate (Pierce, Rockford, Ill.) may be used. PNPP yields a yellow color which may be detected at 405 nm.

In particular, the crosslinking reaction and detection are followed according to the manufacture's instructions included with the crosslinking agent. The polymeric fiber is weighed and placed in a suitable buffer with a pH of about 7 to about 9. The crosslinking reaction is preformed. The polymeric fibers are then washed with deionized H₂O and then incubated with strepavidin-alkaline phosphatase for about 15 to about 30 minutes at a neutral pH to give complexed polymeric fibers. The complexed polymeric fibers are then washed with deionized H₂O and the biotin-strepavidin-alkaline phosphatase is cleaved with about 5 to about 10 mM dithiothretol (DTT) (Sigma, St. Louis, Mo.). The supernatant is collected and the substrate, PNPP, is added. The recovered biotin-strepavidin-alkphosphatase-PNPP moiety is colorometrically quantitated at 405 nm and compared to a standard curve that is prepared using unreacted strepavidin-alkaline phosphatase. The spent wash solutions may be assayed for alkaline phosphatase to determine whether any non-covalently bound material was removed from the fiber.

An additional control may be conducted and the biotin-strepavidin-alkaline phosphatase conjugated to the polymeric fiber may be directly detected and quantitated without cleaving the crosslinking agent as the possibility exists that DTT will affect the alkaline-phosphatase.

Another crosslinking agent such as Bis(sulfosuccinimidyl) suberate (BS³) (Pierce, Rockford, Ill.) reacts with primary amines on both ends of a polymeric fiber such as Capron® hydrophilic nylon. First, the Capron® SJES hydrophilic Nylon fiber is pretreated by successive washes with 2 ml deionized H₂O/10 mg fiber, 2 ml isopropanol/10 mg fiber, and 2 ml 0.1M HCl/10 mg fiber. Then the fibers were washed 4 times with 2 ml deionized H₂O/10 mg fiber followed by a wash of 2 ml PBS/10 mg fiber. The fibers are then soaked in PBS for about 30 to about 60 minutes at room temperature. The fibers are washed 3 times with 2 ml PBS/10 mg fiber. Then, BS³ is used to react with the fiber surface of the polymeric fiber and another compound such as an antigen or enzyme or label by conventional methods in the art. Immunodetection of a given substance may be conducted using conventional methods or kits in the art such as ImmunoPure® DAB (Pierce, Rockford, Ill.).

Polymeric fibers having carboxyl groups, such as Nucrel®, may be derivatived in a similar manner as provided above. Specifically, the fibers are pretreated by successive washes with 2 ml deionized H₂O/10 mg fiber, 2 ml isopropanol/10 mg fiber, and 2 ml 0.1M NH₄OH/10 mg fiber. Then the fibers were washed 4 times with 2 ml deionized H₂O/10 mg fiber followed by a wash of 2 ml PBS/10 mg fiber. The fibers were then soaked in PBS for about 30 to about 60 minutes at room temperature. The fibers were washed 3 times with 2 ml PBS/10 mg fiber. Then a crosslinking agent such as 1-ethyl-3-(3-dimethylaminopropyl)carbodiimide hydrochloride (EDC) (Pierce, Rockford, Ill.) may be used to complex a protein to the polymeric fiber by conventional methods in the art. Detection may be conducted by using conventional methods in the art such as immunodetection.

The surface activity of the derivatived or functionalized polymeric fibers may be analyzed according to Example 2.

### EXAMPLE 4

### Functional Group Density of Polymeric Fibers

The following experiments were conducted on Capron® SJES hydrophilic Nylon sheath/PET core fibers (amine fibers) and the Nucrel® sheath/PP core fibers (carboxylic acid fibers) to determine the functional group density of the fibers of the present invention.

In the following experiments, the following reagents were used:

NHS-biotin; EZ-Link Sulfo-NHS-SS-biotin; #21331 Pierce, Rockford, Ill.

PEO-biotin; EZ-Link Biotin PEO-amine; #21346 Pierce, Rockford, Ill.

EDC or EDAC; 1-ethyl-3-[3-dimethylaminopropyl]carbodiimide Hydrochloride; #D-1769 Sigma, St. Louis, Mo.

DTT; dithiothreitol; #D-9163 Sigma, St. Louis, Mo.

DTNB; 5,5′-dithio-bis(2-nitrobenzoic acid) Sigma, St. Louis, Mo.

1. Capron® Hydrophilic Nylon

Hydrophilic nylon (Capron)® is a copolymer of nylon 6 (about 80%) and poly(ethylene glycol) (about 20%):

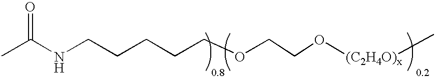

The density of amine groups on the surface of Capron® SJES hydrophilic Nylon fibers of the present invention were assayed by ninhydrin primary amine determination and tritiated (³H) acetic anhydride determination as provided above. Both methods gave similar results of between 0.6 and 1.2 nmol/mg or 150 to 400 nmol/cm³. The results were confirmed by acid/base titration on unbound Capron® SJES hydrophilic Nylon fiber which gave an activity of 2 nmol/mg.

The amount of carboxyl groups on the surface of Capron® SJES hydrophilic Nylon fibers of the present invention was determined using ¹⁴C-methyl amine, condensed onto carboxyl groups in a two-step reaction mediated by 1-ethyl-3-(dimethylaminopropyl)carbodiimide (EDAC) and N-hydroxysulfo-succinimide (NHS).

The original material as supplied by the vendor (ICN Irvine, Calif.) was a solution of methyl amine with a specific radioactivity of 50 μCi/umol. Before the assay, the filters were pre-activated by the same series of washes used in the binding experiments (water, isopropanol, HCl or NaOH, water, then PBS). Briefly, 80 mg of EDAC solid and 80 mg NHS were dissolved in 4 ml of 0.1 M MES, pH 4.5. 2 ml of the EDAC/NHS solution was added to each filter, then incubated at room temperature for 2 hr to form the activated ester. The filter was washed 4 times with 2 ml of PBS, then drained. The methyl amine was diluted by adding 5 μl (0.5 μCi=10 nmol=1.1c6 DPM) of ¹⁴CH₃NH₂ to 95 μl water. The 100 μl of diluted methyl amine was added to 400 μl of 100 mM sodium phosphate, pH 7.2, then the 500 μl of buffered solution was added to the filter. After 30 min at room temperature, the reaction solution was removed, then the filter washed three (3) times with 1 ml PBS, then three (3) times with 1 ml of water. All washes and the filters were counted.

The picomoles incorporated were then calculated from the detected CPM in conjuction with the specific radioactivity and the 14C counting efficiency of the scintillation counter (0.73 CPM/DPM). The Capron® SJES hydrophilic Nylon fibers were found to comprise 1 pmol/mg of carboxyl groups.

2. Nucrel®

Nucrel is an ethylene/methacrylic acid copolymer of the structure:

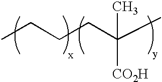

where concentrations are x=about 0.9 and y=about 0.1.

The amount of carboxyl groups on the surface of Nucrel® fibers of the present invention was determined using acid/base titration as provided above. The Nucrel® fibers had a carboxylic acid surface density of 7.3 nmol/mg (or 2000 nmol/cm³).

Additionally, a ¹⁴C-methyl amine assay as described above was conducted to determine the carboxylic acid surface density of the Nucrel® fibers of the present invention. No observable amount of carboxyl groups was found above the baseline.

Using the tritiated (³H) acetic anhydride determination method described above, Nucrel® fibers were found to have excellent reactivity toward acetic anhydride. The results are in provided in Table 5.

TABLE 5

| | Anhydride Reactivity | Anhydride Reactivity |
|---|---|---|
| Density (g/cm³) | (nmol/mg) | (nmol/cm³) |
| 0.41 | 116 | 30000 |
| 0.22 | 130 | 50000 |

Thus, as determined above, the amine group density of Capron® SJES hydrophilic Nylon was about 1 nmol/mg, or 400 nmol/cm³, and the carboxylic acid group density of Capron® SJES hydrophilic Nylon was about 1 pmol/mg, or 400 pmol/cm³. The carboxylic acid group density of Nucrel® was about 7 nmol/mg, or 2000 nmol/cm³. It is important to note that despite the negative results of the ¹⁴C-labeled methyl amine test, the carboxyl group density of the fibers was confirmed on the polymer fibers of the present invention by the excellent specific binding shown by the PEO-biotin assays described below.

The Capron® SJES hydrophilic Nylon results, wherein both amine and carboxyl groups are present on the surface, are consistent as the nylon-6 component is likely to degrade to form both amine and carboxyl end groups. The Nucrel® results are also consistent with the structure of Nucrel®. In further experiments, it was found that nylon-6 has amine functionality as well (about 8 nmol/mg), which is about 20 times higher than that of Capron® SJES hydrophilic Nylon.

Since the activity of nylon-6 seems to be the result of degradation, the fibers of the present invention may be further derivatived such that non-specific binding is minimized. For example, polystyrene sheaths that are substituted with sulfonic acid groups may be used or amine groups may be placed in the surfaces on polyethylene sheaths via plasma polymerization with ammonia. Other methods known in the art may be used.

### EXAMPLE 5

### Biotinylation of Polymeric Fibers

To determine the amount of specific binding and biotinylation of the fibers of the present invention, the following experiments were conducted.

In the following experiments, the following reagents were used:

NHS-biotin; EZ-Link Sulfo-NHS-SS-biotin; #21331 Pierce, Rockford, Ill.

PEO-biotin; EZ-Link Biotin PEO-amine; #21346 Pierce, Rockford, Ill.

EDC or EDAC; 1-ethyl-3-[3-dimethylaminopropyl]carbodiimide Hydrochloride; #D-1769 Sigma, St. Louis, Mo.

DTT; dithiothreitol; #D-9163 Sigma, St. Louis, Mo.

DTNB; 5,5′-dithio-bis(2-nitrobenzoic acid) Sigma, St. Louis, Mo.

1. Pretreatment (Wetting) and Activation

The media of the present invention comprising nylon (Capron® SJES hydrophilic nylon/PET) or Nucrel® (Nucrel 535/PP) fibers were pretreated as follows: about 50 mg of the media were washed in 1 ml of water and 1 ml of isopropanol. The nylon medium was rinsed with 1 ml 4N HCl, and the Nucrel® medium was rinsed with 1ml 1N NaOH. The media were then washed with four times with 1 ml water, and two times with 1 ml PBS.

2. Modification with NHS-Biotin.

Trial 1

500 μl of a 10 mM solution of Sulfo-NHS-SS-Biotin (1 ml PBS, 0.5 ml biotin) were added to each media sample designated for biotinylation. The reaction was allowed to proceed for 2 hours on ice. The samples were then washed 3 times with 1 ml PBS, and then blocked with 1 mg/ml bovine serum albumin (BSA) for 30 minutes at room temperature. Again, the samples were washed 3 times with 1 ml PBS. 1 μl HRP-streptavidin (a 1:1000 dilution) was added to each sample, and allowed to react for 30 minutes at room temperature. The samples were washed with 6 times with 1 ml PBS, and then 500 μl TMB substrate was added. After about 15 seconds, the reacted substrate was transferred to a tube comprising an equal volume (500 μl) of 1N H2SO4 to stop the reaction. The stopped solutions were then diluted 1:10 and the absorbance was read at 450 nm.

It was expected that NHS-biotin would bind specifically to the Capron® SJES hydrophilic Nylon media, but not to the Nucrel® media. As shown in Table 6, the Nucrel® media shows no specific binding. There are indications that the Capron® SJES hydrophilic Nylon media show some degree of specific binding when pretreated (blocked) with BSA, however, the background was high in all cases.

TABLE 6

| | | Capron ® SJES hydrophilic Nylon + |
|---|---|---|
| | Nucrel + NHS-Biotin | NHS-Biotin |
| Treatment | OD 450 | OD 450 |
| no-pretreatment − no-biotin | 0.815 | 0.627 |
| no-pretreatment + biotin | 1.097 | 0.726 |
| pretreatment − no-biotin | 0.622 | 0.691 |
| pretreatment + biotin | 0.648 | 1.206 |

Trial 2

The following was conducted in order to reduce background levels of biotinylation. For this purpose, the experiments were done only with negative controls. The concentration of BSA used for blocking was increased to 5 mg/ml, and then to 10 mg/ml. HRP-streptavidin was diluted more (1:2000) and used on the filters blocked with 10 mg/ml BSA. The wash step between the streptavidin reaction and the substrate addition was increased to 15 ml by using a 5 ml syringe with the sample filter placed inside the barrel. For the Nucrel® media, background levels of binding were reduced by both the 5 mg/ml and 10 mg/ml BSA blocking step to 0.188, and 0.222, respectively. For the Capron® SJES hydrophilic Nylon media, only the 10 mg/ml BSA blocking step reduced background to 0.151 (after 5 mg/ml, the absorbance was still 0.691).

This experiment above was repeated incorporating the changes described above and also, the biotinylation step was incubated at room temperature for 30 minutes, instead of two hours on ice. BSA at a concentration of 10 mg/ml was used for blocking. Samples designated for DTT treatment were incubated with 50 mM DTT for 30 minutes at room temperature. HRP-streptavidin was further diluted (1:5000), and remained in contact with the samples for less than 5 minutes. The media were washed in syringes, then washed media were placed in clean tubes and TMB substrate was added. The substrate reaction was stopped with 1N H₂SO₄, and absorbance was measured at 450 nm. These samples were not diluted before measuring the absorbance.

As shown in Table 3 below, Nucrel® media showed no significant difference in reactivity among the samples. Also, treatment with DTT increased the reactivity rather than reducing it. For the Capron® SJES hydrophilic Nylon media, the background was significantly reduced, especially in those not pretreated. Nevertheless, under these conditions specific binding of the NHS-biotin did not occur.

As shown in Table 7, the overall NHS-Biotin results indicated that strepavidin horseradish peroxidase will not bind specifically to the Nucrel® media under the conditions tested. For the Capron® SJES hydrophilic Nylon media, indications of specific binding were observed under the conditions employed in Trial 1, although backgrounds were quite high. In this case, blocking with BSA is necessary to achieve this degree of specific binding.

TABLE 7

| | | Capron ® SJES hydrophilic |
|---|---|---|
| | Nucrel + NHS-Biotin | Nylon + NHS Biotin |
| Treatment | OD 450 | OD 450 |
| no-pretreatment − no-biotin | 0.483 | 0.018 |
| no-pretreatment + biotin | 0.363 | 0.022 |
| no-pretreatment + biotin + DTT | 1.567 | 0.048 |
| pretreatment − no-biotin | 0.319 | 0.258 |
| pretreatment + biotin | 0.589 | 0.310 |
| pretreatment + biotin + DTT | 0.642 | 0.135 |

Trial 3

The samples were then modified with PEO-Biotin. Specifically, the samples were pretreated (or not) as described above. The biotinylation reaction was done using PEO-biotin. The samples were placed in 0.5 ml of 0.1 M MES buffer, pH 5.5. A 50 mM stock solution of PEO-biotin was prepared, and 25 ml were added to samples designated for treatment. EDC was dissolved in 0.1 M MES, pH 5.5, at 1 mg/ml; 6.25 ml were added to the designated samples. The reaction was incubated for 2 hours at room temperature. The post-biotinylation steps were essentially the same as performed previously, with the exception of the addition of substrate. TMB was diluted 1:5 in dH2O, and placed on each sample for exactly 2 minutes. The solution was removed to an equal volume of 1N H₂SO₄, and the absorbance was measured at 450 nm.

The data in Table 8 show that biotinylation of Nucrel® media with the PEO-biotin was specific on the BSA-pretreated Nucrel® samples, but not specific on the samples without pretreatment. The data also show that, with Capron® SJES hydrophilic Nylon media, there is some degree of specific binding using PEO-biotin when pretreated (blocked) with BSA.

TABLE 8

| | | Capron ® SJES hydrophilic Nylon + |
|---|---|---|
| Treatment | Nucrel + PEO-Biotin OD 450 | PEO-Biotin OD 450 |
| no-pretreatment − no-biotin | 0.104 | 0.470 |
| no-pretreatment + biotin | 0.178 | 0.562 |
| pretreatment − no-biotin | 0.150 | 0.282 |
| pretreatment + biotin | 0.999 | 0.520 |

Trial 4

To further address the problem of high background binding, the amount of sample used was reduced to 5 mg. In a small test experiment, 5 mg of a Nucrel® sample was not pretreated or reacted with biotin. The small amount of sample was reacted with HRP-streptavidin (1:5000), washed in the syringe, and reacted with TMB (1:5 in d-H₂O), for exactly 2 minutes. The measured absorbance of 0.343 was not significantly lower than with 50 mg of sample (0.483).

Trial 5

The NHS-biotinylation experiment described in Trial 2 was repeated in PBS, but the final reaction was a timed (2-minute) incubation with dilute substrate (TMB, 1:5). All other parameters of the experiment were essentially the same as described in Trial 2 above.

Under the conditions of Trial 5, biotinylated Nucrel® media without pretreatment showed activity only slightly above background, and although DTT treatment lowered the reactivity, the difference is not significant. Biotinylated Nucrel® media with pretreatment did show about double the reactivity of the control, and DTT treatment lowered the reactivity back down to background levels. Thus, although the signal-to-noise ratio is not high, there is some indication of specific binding of NHS-biotin to pretreated Nucrel® media under these conditions.

As shown in Table 9, biotinylated Capron® SJES hydrophilic Nylon media without pretreatment showed double the reactivity of the control, and DTT treatment lowered the reactivity to below background levels. Thus, although the signal-to-noise ratio is not high, there is some indication of specific binding of NHS-biotin to Capron® SJES hydrophilic Nylon media under these conditions without pretreatment.

However, biotinylation of pretreated Capron® SJES hydrophilic Nylon media gave a mixed message. The reactivity of the biotinylated sample was lower than the background control, and DTT treatment lowered it further. This is indicative on non-specific binding under these conditions.

TABLE 9

| | | Capron ® SJES hydrophilic |
|---|---|---|
| | Nucrel + NHS-Biotin | Nylon + NHS Biotin |
| Treatment | OD 450 | OD 450 |
| no-pretreatment − no-biotin | 0.151 | 0.180 |
| no-pretreatment + biotin | 0.197 | 0.391 |
| no-pretreatment + biotin + DTT | 0.167 | 0.094 |
| pretreatment − no-biotin | 0.184 | 0.359 |
| pretreatment + biotin | 0.314 | 0.303 |
| pretreatment + biotin + DTT | 0.159 | 0.175 |

Trial 6

The NHS-biotinylation experiment of Trial 5 was repeated with nylon at pH 8.5. All of the reaction steps were the same as previously described, except 50 mM NaHCO₃, pH 8.5, was used instead of PBS. The timed incubation with dilute substrate was also used.

As shown in Table 10, the background was extremely high in samples with or without pretreatment. Biotinylation had the apparent (but likely artifactual) effect of reducing reactivity. Hence, biotinylation of the Capron® SJES hydrophilic Nylon filters at pH 8.5 is not specific.

TABLE 10
Capron ® SJES hydrophilic Nylon + NHS-

| Biotin (pH 8.5) | OD 450 | Dilute OD 450 |
|---|---|---|
| no-pretreatment − no-biotin | 2.128 | 0.238 (1:10) |
| no-pretreatment + biotin | 1.335 | |
| no-pretreatment + biotin + DTT | 0.457 | |
| pretreatment − no-biotin | 2.260 | 0.293 (1:10) |
| pretreatment + biotin | 1.351 | |
| pretreatment + biotin + DTT | 0.507 | |

Trial 7

To determine the degree of biotinylation on both Nucrel® and hydrophilic Capron® SJES hydrophilic Nylon media, the substitution level of biotin on the filters in terms of moles biotin per mass of filter, the following experiment was conducted. Since the NHS-biotin has a disulfide in the middle of the chain, the thiol reagent DTNB (5,5′-bis-Dithio(2-nitrobenzoic acid) was deemed a simple tool for the determination. Briefly, when in its oxidized bis form, DTNB is colorless. When reduced, it is split in half to give yellow thionitrobenzoate (absorbance at 412 nm). Thus, in the presence of a free sulfhydryl, a disulfide exchange reaction occurs in which one half of the DTNB forms a disulfide with the sulfhydryl on the filter, and the other half is released and produces color. To begin with then, it is necessary to generate a free sulfhydryl from the biotin by reducing the internal disulfide by an initial treatment with DTT. After the DTNB reaction, it is also possible to do a second exchange in which a soluble free sulfhydryl reagent is again added to release the other half of DTNB from the filter (producing more color), and regenerate the originally free sulfhydryl.

The complete series of treatments and reactions is listed below. Washing is done between all steps, and each step may be intentionally omitted as appropriate for controls:

1. Pretreat filters with isopropanol, then water;

2. Wash with PBS;

3. React with NHS-biotin in PBS;

4. Wash with PBS;

5. Treat with DTT in PBS to cleave the biotin linker and generate free SH;

6. Wash with PBS;

7. React with DTNB in bicarbonate, measure color in solution;

8. Wash with PBS or bicarbonate; and

9. Treat a second time with DTT, measure color.

The NHS-biotinylation conditions were as previously described. Note that there was no blocking with BSA, since BSA has sulfhydryls that would also react with DTNB. After biotinylation, the samples were incubated in a 5 mM solution of DTT for 30 minutes, at room temperature. Then the filters were washed extensively with PBS, and incubated in a 10 mM DTNB solution (in 50 mM NaHCO3, pH 8.5) for two minutes. The optical density of the solution was measured at 412 nm.

A preliminary experiment was done to test the negative controls (no pretreatment, no biotin, just steps 3 and 4) with the lots of samples used previously. Preliminary results showed that the Capron® SJES hydrophilic Nylon media had a low level of reactivity (0.048), and the Nucrel® media was apparently not reactive. Further negative control experiments were done (no pretreatment, no biotin, with or without the DTT step 3, then DTNB).

As seen in Table 11 below, in the absence of all other reagents, none of the samples reacted with DTNB. When DTT was included, Nucrel® media remained unreactive. This time, however, the Capron® SJES hydrophilic Nylon media produced color. The color might be attributed to DTT, which apparently could not be washed out of Capron® SJES hydrophilic Nylon.

TABLE 11

| | | | | Capron ® |
|---|---|---|---|---|
| | | | Capron ® SJES | SJES |
| No pretreatment | Nucrel | Nucrel | hydrophilic Nylon | hydrophilic |
| No biotin | 2931 | 2894 | 2932 | Nylon 2895 |
| DTNB only | 0 | 0 | 0 | 0.09 |
| DTT + DTNB | 0.019 | 0 | 0.209 | 0.245 |

The complete series of reactions was done, including a second treatment with DTT. In this experiment, following DTNB-treatment, the samples were washed, incubated with additional DTT for 2 minutes, and the OD of this solution was also measured.

As seen in Table 12 below, after step 4, the negative control gave the highest reading, and the pretreated samples had a lower reading than the non-pretreated samples. After step 5, the negative control still had a high background. The pretreated samples had a higher reading than the non-pretreated samples, but the presence of biotin did not appear to increase reactivity.

TABLE 12

| | | |
|---|---|---|
| Capron ® SJES hydrophilic | after step 4 | after step 5 |

| | | | | |
|---|---|---|---|---|
| Nylon + DTNB | Assay 1 | Assay 2 | Assay 1 | Assay 2 |

| | | | | |
|---|---|---|---|---|
| No-pretreatment − no-biotin | 0.214 | 0.160 | 0.181 | 0.305 |
| No-pretreatment + biotin | 0.175 | 0.092 | 0.219 | 0.066 |
| Pretreatment − no-biotin | 0.133 | 0.103 | 0.318 | 0.354 |
| Pretreatment + biotin | 0.096 | 0.066 | 0.272 | 0.340 |

For the Nucrel® samples, as shown in Table 13, the negative control was zero and the presence of biotin and pretreatment caused the reactivity to be slightly higher. Subsequent DTT treatment failed to produce color. Both the DTNB and subsequent DTT treatments indicate very low levels of biotin binding. Thus, the substitution level could not be determined by this methodology.

TABLE 13

| | after step 4 | | after step 5 | |
|---|---|---|---|---|
| Nucrel + DTNB | Assay 1 | Assay 2 | Assay 1 | Assay 2 |
| No-pretreatment − no-biotin | 0.0 | 0.0 | 0.0 | 0.0 |
| No-pretreatment + biotin | 0.006 | 0.0 | 0.0 | 0.0 |
| Pretreatment − no-biotin | 0.0 | 0.024 | 0.0 | 0.001 |
| Pretreatment + biotin | 0.059 | 0.059 | 0.0 | 0.0 |

The following is a summary of the additional biotinylation work: The NHS-biotinylation experiment was repeated in PBS, but the final reaction was a timed (2-minute) incubation with dilute substrate (TMB, 1:5). All other parameters of the experiment were essentially the same as described above.

As seen in Table 14 below, biotinylated Nucrel® media without pretreatment showed activity only slightly above background, and although DTT treatment lowered the reactivity, the difference is probably not significant. Biotinylated Nucrel® media with pretreatment did show almost double the reactivity of the control, and DTT treatment lowered the reactivity back down to background levels. Thus, although the signal-to-noise ratio is not high, there is some indication of specific binding of NHS-biotin to pretreated Nucrel® media.

TABLE 14

| Nucrel + NHS-Biotin | OD450 |
|---|---|
| no-pretreatment − no-biotin | 0.151 |
| no-pretreatment + biotin | 0.197 |
| no-pretreatment + biotin + DTT | 0.167 |
| pretreatment − no-biotin | 0.184 |
| pretreatment + biotin | 0.314 |
| pretreatment + biotin + DTT | 0.159 |

As seen in Table 15 below, biotinylated Capron® SJES hydrophilic Nylon media without pretreatment showed double the reactivity of the control, and DTT treatment lowered the reactivity to below background levels. Thus, although the signal-to-noise ratio is not high, there is some indication of specific binding of NHS-biotin to the Capron® SJES hydrophilic Nylon media without pretreatment.

Biotinylation of pretreated Capron® SJES hydrophilic Nylon media gave mixed results. The reactivity of the biotinylated sample was lower than the background control, and DTT treatment lowered it further. This is likely indicative of non-specific binding.

TABLE 15

| Capron ® SJES hydrophilic | |
|---|---|
| Nylon + NHS-Biotin | OD450 |
| no-pretreatment − no-biotin | 0.180 |
| no-pretreatment + biotin | 0.391 |
| no-pretreatment + biotin + DTT | 0.094 |
| pretreatment − no-biotin | 0.359 |
| pretreatment + biotin | 0.303 |
| pretreatment + biotin + DTT | 0.175 |

The NHS-biotinylation experiment was repeated with Capron® SJES hydrophilic Nylon samples at pH 8.5. All of the reaction steps were the same as previously described, except 50 mM NaHCO₃, pH 8.5, was used instead of PBS. The timed incubation with dilute substrate was also used.

As seen in Table 16 below, the background was extremely high in samples with or without pretreatment. Biotinylation had the apparent (but likely artifactual) effect of reducing reactivity. Hence, biotinylation of the Capron® SJES hydrophilic Nylon samples at pH 8.5 is not specific.

TABLE 16

| Capron ® SJES hydrophilic Nylon + | |
|---|---|
| NHS-Biotin (pH 8.5) | OD450 |
| no-pretreatment − no-biotin | 2.128, 0.238 (1:10) |
| no-pretreatment + biotin | 1.335 |
| no-pretreatment + biotin + DTT | 0.457 |
| pretreatment − no-biotin | 2.260, 0.293 (1:10) |
| pretreatment + biotin | 1.351 |
| pretreatment + biotin + DTT | 0.507 |

To the extent necessary to understand or complete the disclosure of the present invention, all publications, patents, and patent applications mentioned herein are expressly incorporated by reference therein to the same extent as though each were individually so incorporated.

Having thus described exemplary embodiments of the present invention, it should be noted by those skilled in the art that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A medium for analyzing at least one substance in a mixture comprising a network of at least one polymeric fiber having a derivatized polymeric surface which allows immobilization of at least one specific binding agent thereon in a highly dispersed and randomly spaced orientation which forms a tortuous interstitial path for passage of the mixture therethrough.

2. The medium of claim 1, wherein the network is substantially self-sustaining, three-dimensional, and substantially water insoluble.

3. The medium of claim 1, wherein the network further comprises a second polymeric fiber.

4. The medium of claim 1, wherein the network further comprises derivatized beads.

5. The medium of claim 1, wherein randomly spaced points of contact of the polymeric fiber are bonded to each other.

6. The medium of claim 1, wherein the polymeric fiber comprises a thermoplastic polymer.

7. The medium of claim 1, wherein the polymeric fiber is a sheath-core bicomponent fiber.

8. The medium of claim 1, wherein the polymeric fiber is a multi-component fiber.

9. The medium of claim 3, wherein the second polymeric fiber comprises a derivatized polymeric surface which allows immobilization of a second specific binding agent thereon.

10. The medium of claim 6, wherein the thermoplastic polymer is selected from the group consisting of hydrocarbon resins, polyamides, polyethylene, polyvinyl chloride, and polyesters such as copolymers of ethylene, propylene, ethylene methacrylic acid, ethylene acrylate acid, ethylene-vinyl acetate, ethylene methyl acrylate, polystyrene, nylon 6, polyethylene terephthalate, polybutylene terephthalate, and derivatives thereof.

11. The medium of claim 6, wherein the thermoplastic polymer is a copolymer of nylon 6, polyethylene oxide diamine, ethylene methacrylic acid, or a combination thereof.

12. The medium of claim 6, wherein the thermoplastic polymer is a copolymer of ethylene and methacrylic acid.

13. The medium of claim 6, wherein the thermoplastic polymer is a copolymer of ethylene and acrylic acid.

14. The medium of claim 6, wherein the thermoplastic polymer is Nucrel® or Capron® SJES hydrophilic nylon.

15. The medium of claim 1, made by continuously spinning a plurality of fibers having at least a surface comprising the thermoplastic polymer through a plurality of openings in a die, collecting the fibers on a continuously moving surface to form a highly entangled web of the fibers in the form of the network of highly dispersed continuous fibers randomly spaced primarily in the direction of movement of the moving surface, gathering the network, heating network to bond the fibers to each other at their points of contact, and cooling said network to give the medium.

16. The medium of claim 15, wherein continuously spinning is selected from the group consisting of melt spinning, melt blowing, spun bonding, solution spinning, and cold drawing techniques.

17. The medium of claim 15, wherein the network is heated by steam.

18. An assay matrix for a chemical or biological assay comprising the medium of claim 1 and at least one specific binding agent immobilized thereon.

19. An assay system comprising the assay matrix of claim 17.

20. The assay system of claim 19, wherein the assay system is an assay tray, a column, a hypodermic needle, a membrane, or a microcentrifuge tube.

21. A kit comprising the medium of claim 1 packaged together with at least one chemical or biological assay reagent.

22. The kit of claim 21, further including instructions for use.

23. A method for analyzing at least one substance in a mixture comprising immobilizing at least one specific binding agent to a network of at least one polymeric fiber having a polymeric surface which allows immobilization of at least one specific binding agent thereon in a highly dispersed and randomly spaced orientation which forms a tortuous interstitial path for passage of the mixture therethrough.

24. The method of claim 23, further comprising functionalizing the polymeric surface.

25. The method of claim 23, further comprising treating the polymeric surface to confer a greater specificity, reactivity, or affinity to the substance.

26. The method of claim 23, wherein the substance is a chemical substance or a biological substance that specifically binds to the specific binding agent.

27. The method of claim 24, wherein the biological substance is selected from the group consisting of amino acid molecules, peptides, polypeptides, nucleic acid molecules, polynucleotides, sugars, carbohydrates, lipids, and derivatives thereof.

28. The method of claim 23, wherein the substance is a therapeutic agent.

29. The method of claim 23, wherein the polymeric fiber comprises a plurality of interaction sites capable of specific or covalent bonding with the specific binding agent, a crosslinking agent, or both.

30. The method of claim 23, wherein the substance is isolated, purified, or separated from the mixture by specific, ionic, or covalent bonding to the medium, a crosslinking agent, the specific binding agent, or a combination thereof.

31. The method of claim 30, wherein the same substance or another substance is isolated, purified, or separated from the mixture by physical entrapment.

32. The method of claim 22, further comprising eluting the substance from the medium.
